(19) United States
(12) Patent Application Publication
(10) Pub. No.: US 2021/0335536 A1
(43) Pub. Date: Oct. 28, 2021

(54) Method of Reducing Leakage Magnetic Flux for a Shell-type transformer or Inductor

(71) Applicant: Jacobus Johannes Van Der Merwe, Villieria (ZA)

(72) Inventor: Jacobus Johannes Van Der Merwe, Villieria (ZA)

(21) Appl. No.: 17/366,351

(22) Filed: Jul. 2, 2021

Related U.S. Application Data
(63) Continuation-in-part of application No. PCT/ZA2020/050001, filed on Jan. 3, 2020.

(30) Foreign Application Priority Data
Jan. 4, 2019 (ZA) 2019/00075

(51) Int. Cl. H01F 27/34; H01F 27/24; H01F 27/02; H01F 27/245; H01F 27/28; H01F 41/02

(52) U.S. Cl. CPC H01F 27/346; H01F 27/24; H01F 41/02; H01F 27/245; H01F 27/28; H01F 27/02

(57) ABSTRACT

A Method of reducing leakage magnetic flux for a shell-type transformer or inductor is disclosed. The magnetic flux density is reduced between flux transitional areas and corner losses are reduced.

Advantageous, the method may also help to reduce the operational temperature of the transformer or inductor (of any size) during normal use. The centre of the ferromagnetic core is cooled. The effective outside area of the core is enlarged. The transformer core is organized to have any number of cooling holes (400.3.1), (400.3.2) without reducing the area for magnetic flux to circulate around the core. Several embodiments are disclosed. Various improvements may be made without departing from the methods and principals disclosed in this patent.

### CROSS REFERENCE TO RELATED APPLICATION

This invention is a continuation-in-part patent application and claims the benefit of and takes priority from PCT application: PCT/ZA2020/050001, entitled: Method of Cooling a Shell-type Transformer or Inductor, filed on 3 Jan. 2020, which in claims the benefit of and takes priority from South African Patent Application No. 2019/00075 filed on Jan. 4, 2019, the contents of which are incorporated herein by reference.

### INTRODUCTION

Generally, this invention may be referred to as an electric apparatus. Dependent on the functionality, the electric apparatus may either be configured as a transformer or as an inductor. More specifically, the organization of the electromagnetic coil(s) and electrical connections, made to the coil(s), (during normal operation) may determine the functional use of the electrical apparatus. Although the description and embodiments may refer to a “transformer” it will clearly be understood that similar methods may be used to organize an inductor, according to known methods.

This invention discloses a method or process of reducing leakage magnetic flux for a shell-type transformer or shell-type inductor. Advantageous, the invention may also cause a reduction of the operational temperature of the transformer or inductor during normal use.

Both large and small transformers may be organized in accordance with the invention. With Global Heating on the rise, Mains Distribution Transformers may be exposed to direct sunlight and adverse temperature conditions necessitating improved thermal management methods.

In particular, the invention disclose a method, apparatus and system for decreasing the magnetic flux density, at flux transitional areas between laminated plates in a transformer or inductor, in order to reduce leakage flux. Partially rounded corners may reduce flux compression at sharp corners.

### Object

According to one broad aspect of the invention; there is provided a method of decreasing the magnetic flux density (B), during normal use, at flux transitional areas between laminated transformer or laminated inductor plates.

According to another aspect of the invention, the natural resonance frequency of the ferromagnetic core of a transformer or inductor may be reduced or altered.

According to another aspect of the invention, vibrations and/or transmitted vibrations may be reduced, via modification of the transient impulse response parameters.

According to another aspect of the invention, the outside core area may be increased, in order to enlarge the area for heat to escape, without (or minimally) adding extra material and weight to the transformer or inductor. Air, oil or similar may circulate through the core of the transformer or inductor.

According to another aspect of the invention; there is provided a method of decreasing the electrical resistance of the conducting wire of a transformer or inductor, during normal use, by improved thermal management.

According to another aspect of the invention, corner losses may be reduced via substantially rounded corners of slits used in the core.

According to yet another aspect of the invention, the performance of the transformer or inductor is improved without, (or minimally), impacting on known equations used by transformer manufacturers, for example: window size, core area, bobbin dimensions, etc.

Prior Art Transformers

The operating principals of prior art transformers and the mathematical equations relating to their operation are well documented and therefore not repeated in this document. E-I type laminations has been known since at least 1923, as shown in U.S. Pat. No. 1,579,955. No previous art shell-type transformer, constructed from E-I type of laminations, was organized as disclosed in this patent.

Prior Art Inductors

The ferromagnetic core of an inductor (or choke) may be organized similar to a shell-type transformer. In some prior art systems the core was purposely organized to have an air-gap, in the region of the centre limb, according to known methods. Principals disclosed in this patent apply equally to shell-type inductor cores. Similarly, for a shell-type inductor organized in accordance with the invention, the core may (or may not) purposely be organized to have an air-gap in the region of the centre limb.

Laminated vs. Un-laminated Cores

Principals disclosed in this patent apply to laminated and to un-laminated cores, as for example used in inductors/transformers of switch-mode power supply systems, etc.

### Prior Art Patents

Patent GB 493 739 A, 13 Oct. 1938, disclose a transformer with “transverse cooling passages, in which magnetic circuit the plates are overlapping”. The overlapping arrangement of the plates may cause high leakage flux, during normal operation.

Patent GB 1200 606 A, 29 Jul. 1970, disclose a transformer with cooling gaps constructed from “insertion-pieces”, so that; seven or six different types of laminations may be required. No indication is given in the patent as to how the large number of different laminations may be kept in position, relative to each other, during assembly. Loose plates may potentially increase generated noise.

Patent GB 731 215 A (GENERAL ELECTRIC COMPANY), 1 Jun. 1955, disclose a three-phase, three-legged transformer core structure with air gaps, (the design is based on a core type transformer—the present invention relates to a shell-type transformer).

Patent JP H03147307 A (TOSHIBA CORP), 24 Jun. 1991 disclose a three-legged transformer core structure (according to the figures). No indication is given in this patent of the use of “E” and “I” like laminations.

Patent EP 2472 534 A1 (Mitsubishi Electric Corporation) disclose a transformer where “a slit is formed in at least a magnetic sheet which faces an inner peripheral surface of the coil in a stacking direction of the plurality of magnetic sheets . . . ”. No mention is made in this patent that; the slits may be organized to reduce corner losses or the use of “E” and “I” like laminations or the use of magnetic shunts.

Patent US 2012/0299686 A1 (Mitsubishi Electric Corporation) disclose a: Static Apparatus with “Slits extending in an axial direction of the shaft portion are formed in at least a surface layer magnetic plates constituting the main surface, of the plurality of magnetic plates”. No mention is made in this patent of a reduction in corner losses and multiple aspects disclosed in the current patent application.

Shell-Type vs. Core-Type Transformers

Transformers may broadly be classified as core-type transformers or shell-type transformers. Shell-type transformers are organized differently to core-type transformers and may be organized so that the side limbs of the core may form a protective shell around the electromagnetic coils wound around the centre limb of the core.

Shell-type transformers are the most commonly used transformers in the world and offer various advantages over core-type transformers, including:
Reduced leakage flux.
Better short-circuit characteristics.
Protection of the electromagnetic coils, (during transportation or installation, etc).

It will be noted that; in all of above mentioned prior art patents, the area available for magnetic flux to flow, via the core, is reduced (due to the cooling passage—encircled by the coil(s)). If the core area is increased, in order to compensate for the cooling passages (in mentioned prior art patents), this may lead to an increase in the diametric size of the electromagnetic coils and may require additional material to construct the coils, resulting in increased DC resistance of the coils and additional cost.

The electrical power rating of a transformer is a function of the transformer's core area. Cooling passages, (as used in previous art systems) may reduce the transformer's electrical power rating. Slits (as used in prior art systems) may impact on the transformer's electrical power rating and may require compensatory measures to maintain the power rating of the transformer.

Sharp corners, in the design of a transformer core, should preferably be avoided since flux may be compressed to core saturation flux densities resulting in leakage flux (at the sharp corners). See: Excerpt from the proceedings of the 2013 COMSOL Conference in Rotterdam, The Influence of Core and Material Nonlinearities to Corner Losses of Inductive Elements, Magdalena Pruskarczyk, Brince Jamieson, Wojciech Jurczak, ABB Corporate Research Centre, Karków, Poland.

It will further be noted that in all of above mentioned prior art patents, electrical windings may partially or fully encircle the cooling passages, thereby limiting air or oil flow through the cooling passages.

No mentioned prior art patent mention the use of slits, (or similar) in un-laminated cores.

Advances Over Prior Art Systems Include:
1. No reduction of the ferromagnetic flux path of the transformer core.
2. No restriction of air or oil flow (or similar) through the cooling slits due to the electromagnetic coils.
3. No special construction techniques required to keep components in position relative to each other.
4. No or limited increase in the required number of different lamination profiles.
5. May be used with magnetic shunts.
6. Symmetrical ferromagnetic path-length, in the direct vicinity of the (center) electromagnetic coils.
7. Average ferromagnetic path-length is increased (see text), in all laminated plates, resulting in a reduction of the maximum flux level.
8. Reduction of leakage magnetic flux, (see text and test transformer).
9. Reduction of the flux density, at the flux transition areas, of the side limbs.
10. Reduction of corner losses, in laminated and un-laminated cores.

### BACKGROUND

Shell-type transformers (and inductors), constructed from “E” and “I” type of laminations, are known to generate magnetic leakage flux. Flux may escape between flux transitional areas, due to a known flux crowding effect, during normal use.

Leakage flux may induce EMI generated noise in electronic equipment. For example, in sensitive medical equipment, micro (μ) ampere signal levels need to be measured in patients via EEG equipment, while the patient also need to be protected from ground loops (between different medical instruments connected to a patient) and mains voltage levels via a transformer.

Electric and electronic equipment need to comply with ever increasingly stricter levels of EMI and noise emission levels.

Leakage flux may easily be measured via a search coil (also called a pick-up coil, induction coil or measuring coil). Generally, a cylindrical coil with an air-core is used. The cross-sectional area of the coil and the number of turns characterize the coil. A search coil may be calibrated in a known magnetic field.

A test transformer displayed a reduction in leakage flux of approximately 33% peak-to-peak noise level, compared to a similar prior art transformer, during no-load and approximately 45% improvement during max resistive loading.

If the average operating temperature of a transformer is reduced, the efficiency of the transformer may be improved. It is a well known fact that; the electrical resistance of a conductor will increase with an increase in temperature. Temperature rise in a transformer may (over a period of time) degrade the insulation of electrical wires, ultimately resulting in failure.

Current three-phase transformers use a known shared 3 legged structure. The reasoning behind this design is that material is saved (due to a common leg) resulting in reduced transformer weight and manufacturing cost. In the inventor's opinion, mentioned design is a double edged sword because the area for heat to escape is reduced, resulting in higher operational temperatures, (see equation 1), increased electrical resistance, wasted energy and increased carbon released into the atmosphere. The combined effect of multiple legacy three-phase transformer systems in the World needs serious attention. This invention may also be used in multiphase systems

The current invention may be used to thermally reduce the average working temperature of high power mains distribution transformers or low power transformers, used in for example; electronic equipment (or inductors used in switch-mode power supplies), etc.

Military and Aviation Applications

Transformers used in military applications may be subjected to additional stress and may require increased reliability. In order to reduce size, some military transformers may be operated at relative high frequencies, (for example 400 Hz), as documented in: Electromagnetic Concepts & Applications, second edition, ISBN 0-13-248931-7 01, p 300, in the Public Domain. The increased frequency may have an adverse effect on the generation of eddy currents resulting in increased heat in the transformer components.

Transformers used in aircrafts may operate on similar principals to reduce the transformer weight and may suffer similar problems. Cooling methods, as disclosed in this patent, may provide relief to the problem.

Transformer Distance to Load There are no safety restrictions on where air-cooled transformers may be placed. This may allow air-cooled transformers to be placed close to loads, thereby saving on cabling cost and power.

Transformer Losses

Losses in a transformer are caused by copper losses and core losses. A short-circuit test may be used to determine copper losses. Core losses comprise; hysteresis and eddy current losses and may be determined by an open-circuit test. Core losses are constant for all conditions of load. In contrast copper losses depend on the load current. The efficiency of a transformer may be defined as η=(output)/(output+losses). Leakage flux may increase transformer losses.

Hysteresis and eddy current losses are a function of the maximum flux density, in accordance with known equations. Accordingly, one possible method of limiting temperature rise is by reducing the maximum flux level. In the Inventors opinion, this approach is undesirable, because more wire is required to construct the coils, thereby increasing the DC resistance of the coils, adding to the transformer weight and increasing the manufacturing cost.

If the core temperature can be reduced, by methods as disclosed in this patent, the maximum flux level, used in the transformer during normal use, may be increased (while still avoiding saturation of the core). This may result in savings on the construction materials used to construct the coils.

Patent

The invention will now be described: The design and principal of operation are not limited to shown embodiments. Simple and economical construction methods are taken into account and measures to limit electromagnetic losses.

Transformer

For a single-phase, shell-type transformer, the primary and secondary coil(s) may encircle a centre limb of the transformer core, while two side limbs of the core may form a protective shell, partly enclosing the windings.

It will be realized that any improvements to a transformer should not affect magnetic or electric parameters. The reluctance of the core and resulting magnetic flux flow should preferably be unaffected with no increase in eddy current or hysteresis losses.

For a single-phase, shell-type transformer, in accordance with the invention; the two side limbs, of the core, forming the protective shell, may be organized to have one or more slits, holes, cavities (or similar) cut into the side limbs. The air-gaps (slits or hollow cavities) may be organized to be in the same direction as the main magnetic flux flow, in the side limbs.

It will be realized, that the effective cross-sectional core area of the side limbs may be designed to remain the same (compared to the cross-sectional core area of the side limbs of a previous art shell-type transformer, with a similar power rating), while having one or more slits in the side limbs. The flux flow is a function of the reluctance. The reluctance in turn, is a function of the cross-sectional area of the core.

Eddy current losses may be reduced by using laminated plates in the core of the transformer, according to known methods. In un-laminated core's, known materials may be used to reduce eddy currents.

The average ferromagnetic flux path-length around the core may increase, in all laminated plates, (due to the fact that some of the magnetic flux may have to travel a slightly longer path around the slits). Advantageously, the slightly longer path-length may help to reduce the maximum flux level, which may in turn help to reduce the operational temperature of the transformer further. By organizing the slits to have rounded edges (see diagrams), a partial smooth flux path around sharp corners may be created.

The nominal longer average magnetic path length may be offset by a significant increase of the surface area of the core exposed to air, oil of similar. The two side limbs may therefore act as a heat-sink to reduce the thermal heat of the transformer, generated during normal use, while not (or minimally) electrically or magnetically interfering with the operation of the transformer. It will be noted that the slits may help to internally cool the core.

A single slit in each side path (or side limb) may approximately increase the surface area of the core by 27%. If only areas of the core, not covered by wire, is taken into account this rises to approximately 35%.

For a small transformer (with a single slit in each side limb), the average magnetic path-length may increase by approximately 1%-2% (dependent on the dimensions of the slit).

It will be realized that slits (or similar) may cause a “chimney” effect, (almost like a fire place with a chimney), by which air may continuously be sucked through the slits, via the hot core, in order to improve the air (or oil) flow, through the slits.

Due to the orientation of the slits, (compared to the laminated sections), the slits may further help to reduce eddy currents in the core. This process may become clearer from the diagrammatic drawings.

In one possible embodiment, a transformer constructed according to the disclosed method, may thus be organized as following: The transformer may have a ferromagnetic core and may be constructed from laminated ferromagnetic sections.

A shell-type transformer may be designed using known equations and materials. The required effective core area (for the power rating of the transformer) may be computed. The size and diameter of the center and two side limbs may be designed, so that magnetic saturation may be avoided for the given magnetic flux level etc. using known methods.

One or more slits may (for example) be laser cut, or punched into the side limbs, in the same main direction as the magnetic flux flow in the limbs. Through careful design, the effective ferromagnetic cross-sectional area of the side limbs (with the slit(s) cut into the limbs) may be designed to be the same as the cross-sectional area of the side limbs of a previous art transformer with the same power rating. If required the size and cross-sectional areas of the side limbs may be slightly enlarged to accommodate the slits (or similar).

The primary and secondary coils may be constructed from insulated electrically conducting wire. The primary and secondary coils may encircle the center limb of the core. The coils may be wound around a bobbin etc, using known methods. The primary and secondary coils may encircle the core and each other. Or the primary and secondary coils may be positioned in-line with each other according to known methods.

If the core is constructed from “E” and “I” like laminations; the slits in the side limbs of the “E” laminations, may be organized so that the slits do not extend all the way towards the “I” laminations, during final assembly of the core. Stated alternatively; a small portion of ferromagnetic material may be left in tact at the endpoints of the side limbs of the “E” laminations.

In Operation

In operation an AC voltage or current may be electrically connected to the primary coil(s). The primary coil(s) may generate a differential flux component in the ferromagnetic core. A voltage or current may be induced in the secondary coil(s), according to known methods.

During normal operation’ the temperature of the core (and other components of the transformer) may increase. This may increase the electrical resistance of the coils. Heat radiated from the core, via infra red radiation and due to the relative close proximity of the electromagnetic coils to the core, may reflect energy back towards the coil(s) causing a feedback effect, (almost like a mirror). This may further increase the electrical resistance of the coil(s).

Air, oil or similar may circulate around the transformer. The air (or oil) may also circulate through the core via the slits (or air gaps) cut into the side limbs of the core. This may reduce the thermal temperature of the transformer's components. Reducing the temperature may help to increase the efficiency of the transformer and may increase the lifespan and reliability of the transformer.

Magnetic flux, generated by the primary coil(s), may circulate around the core. The magnetic flux may divide (with most of the flux following the shortest path), at the side limbs, so that the flux divide and follow the ferromagnetic core path around the slits (in the “E” laminated sections). The flux may recombine, (over a larger core area), before jumping or transitioning to the “I” laminations, or vice versa.

It will be noted that the magnetic flux density may be reduced, between the flux transitional areas, where the flux jumps from the side legs of the “E” laminations towards the “I” laminations, and vice versa, because the flux is distributed over a larger core area.

Because the flux density may be lowered, (as a result of the organization), at flux transitional areas, this may result in a reduction of leakage flux, during normal operation.

Size of the Holes

It will clearly be noted that the hole(s) or slits, may be organized to have any convenient size. Obviously, the size of the slits or holes may be optimized for the size of the transformer and may be designed according to Customer requirements. The core may have any number of holes or slits. The slits may be organized to be evenly spaced apart or any other spacing arrangement may be used. Slit (or hole) sizes may be uniform or dissimilar sizes may be used in the same transformer. Preferably, the slits may be organized to have rounded corners or substantially rounded corners, thereby aiding to reduce corner losses.

Transformer Core

The core of the transformer may be constructed using known materials and methods. The material used to construct the core of the transformer may be ferromagnetic and may be organized to form a closed or substantially closed magnetic flux path. Examples may include: silicon steel, electric steel or any other suitable magnetic material may be used.

The core may be constructed as a number of separate sections in order to facilitate the winding or manufacturing process of the coils around the core and may be mechanically joined at a later stage to form the disclosed structure.

Transformer Temperature Rise

Various models may be used to estimate the temperature rise of a transformer, but generally, the temperature rise may be a function of the surface area of the transformer. The temperature rise of a transformer, during normal operation, is directly related to transformer losses and may approximately be described by:

ΔT=(PΣ/A_{T})^{0.833} [1], where

ΔT=Temperature Rise in ° C.

PΣ=Total transformer Losses,

A_{T}=Surface area of transformer in cm²

From equation [1], it will be noticed that; if the surface area of the transformer, A_{T} is increased, the temperature increase may be reduced.

If three (3) slits are used in each side-limb, the area may approximately increase by 81%-105%, (3×27% or 3×35%).

The increase in resistance of a conductor with temperature may approximately be described by:

R_{T}=R_{f}[1+α(T−T_{R})] [2], where

R_{f}=Resistance at reference temperature,

T=Temperature,

T_{R}=Reference temperature

α=Temperature coefficient of material.

For a Class H transformer with an allowed temperature rise of 150° C., over ambient temperature, constructed from copper (α=0.004041), the resistance of both the primary and secondary windings may increase by approximately 61%. This further emphasizes the need to keep I²R losses to a minimum.

Similar arguments apply if the windings are constructed from aluminum or other metals.

If an equivalent circuit diagram, of a practical iron core transformer is studied (as for example shown in: Electric Circuit Analysis, Robert A. Bartkowiak, ISBN 0-06-040463-9, p 615) it may be realized that transformer losses may be reduced if leakage flux is reduced.

Magnetic Shunts

Some transformers, for example, transformers used in microwave ovens, (to energize the magnetron-microwave oven transformer or MOT), makes use of known magnetic shunts as part of their design. The invention may be organized to accommodate one or more magnetic shunts, for example, by positioning shunts between holes. This may become clearer as shown in the diagrammatic drawings.

Ferroresonant transformers (or constant voltage transformers) are known to use a resonant effect, created via, inter alia, magnetic shunts and a capacitor. A shell-type transformer may be organized to function as a ferroresonant transformer, in accordance with the invention. One or more slits may be organized in the side limbs of the transformer core. This may help with thermal cooling of the device.

It will be noted that; if magnetic shunts are organized in the design of the electric apparatus (of the current invention), it will exclude the use of the electric apparatus as an inductor. Stated alternatively; if magnetic shunts are organized in the design of the electric apparatus (of the current invention), the electric apparatus may only be used as a transformer.

Eddy Currents

Eddy currents are generally considered undesirable in any transformer. There are well documented mathematical equations describing eddy currents. Eddy currents are, inter alia, a function of the material used, the maximum magnetic flux density and the area of the material. Previous art systems used laminated plates to reduce eddy currents. Generally, the thinner the laminations the less eddy currents are generated.

This is partly due to the fact that; less lines of magnetic force (or flux) can travel along a smaller cross-sectional area of ferromagnetic material.

It will be noted that; individual sections of the side limbs, of a transformer, separated by one or more slits, in accordance with the invention, may be smaller. This may help to reduce eddy currents.

Multi-Phase Transformer Systems

The invention is not limited to a single phase system, but multi-phase systems may be constructed on similar principals as disclosed. For example; a shell-type three-phase transformer system, with five (5) limbs, constructed from laminated plates, may be organized in accordance with the invention. Any outside limb section of the shell-type core may contain any number of cavities in accordance with the invention. The three centre limbs may be encircled by primary and secondary electromagnetic coils, according to known methods. Any type of vector configuration (star, delta, etc.) may be used with a multi-phase transformer.

Three (3) separate single-phase shell-type transformers, constructed in accordance with the invention, may be used, to operate as a transformer bank in a three-phase system. Separate transformers may allow for better cooling and may allow for easier maintenance and replacement of individual phases if required, etc.

Magnetic shunts may be used to protect the transformers from excessive power demands, for example if one or more secondary circuits of the transformer are short-circuited.

Noise, generated by a three-phase transformer and/or leakage flux may be reduced if the three-phase transformer is organized in accordance with the invention.

Frequency Effects

A three-phase transformer is operated via three signals, where there is a phase (ϕ) shift of 120 degrees between each signal. The effect on the core may be:

X(t)=A cos(w(t)+ϕ₁)+A cos(w(t)+ϕ₂)+A cos(w(t)+ϕ₃), [3]

Due to the 120 degree phase differences, equation [3] may be reduced to:

X(t)=A cos[w(t)+ϕ(t)+[ϕ(t)−ϕ(t)]], [4]

This happens under ideal conditions in a balanced system. In real world conditions, differences in inductance levels may exist, (between phases), due to different path lengths, different voltage levels, (between phases) may exist, different loading conditions, (between phases) may exist, etc. By way of example: the first phase may be resistively loaded, the second phase may be capacitive loaded while the third phase may be inductive loaded (or similar) at any instance in time.

Simplified, for a 2-phase system, the effect may be described by:

$$\begin{matrix}cos ( A \pm B ) = cos A cos B \pm sin A sin B , & [ 5 ] \\ cos Acos B = \frac{1}{2} [ cos ( A + B ) + cos ( A - B ) ] , & [ 6 ]\end{matrix}$$

A heterodyning effect is demonstrated in equation [6], which results in the creation of additional higher and lower frequencies. Inter-modulation and more known signal processing phenomena may occur.

Under real world conditions, a bank of separate transformers may generate fewer harmonics in the mains system. The cost of using a transformer bank is approximately 20% more, (compared to a three-phase transformer), but with the consequences of climate change, increased efficient transformers may be phased in via carbon reduction legislation and international agreements. There is clear room for improvement, because core-type transformers are known to produce more leakage flux than shell-type transformers.

In an interesting article: The Measurement and Evaluation of Distribution Transformer Losses Under Non-Linear Loading, IEEE Power Engineering Society General Meeting, Denver Colo., Jun. 9, 2004. PESGM 2004-000721, Aleksandar Damnjanovic, Ph.D., Member IEEE and Gregory Ferguson, BSc., Life Member IEEE. The authors discuss the effects of harmonic-related losses.

The Authors also demonstrate “misleading claims” relating to distribution transformers, with efficiency claims as high as 98%. If the accuracy error of testing instrumentation is taken into account the efficiency may in fact be only 96.5%.

This emphasize the inventors point that; it is possible to increase the efficiency of transformers used in mains distribution systems further, inter alia by reducing leakage flux and corner losses.

Transformer Hum

Transformers are known to generate audible hum or buzz during normal operation. This may cause annoyance to people. The designed magnetic flux density is a critical function that may determine no-load generated noise levels. Transformer noise is inter alia caused by a known magnetostriction effect.

Advantageous, magnetostrition noise may be reduced due to a reduction in the magnetic flux density between flux transitional areas. In larger transformers, step-lap joints between pillars and yokes are known to reduce noise. Currently there exists no similar method of reducing noise in small shell-type transformers.

Natural Mechanical Resonance Frequency

Acoustic resonance is a known characteristic of sound waves, to be amplified at frequencies coinciding with an objects natural resonance frequency. The natural mechanical resonance frequency (of a transformer core) may be modified or optimized, due to methods disclosed in this patent. This may help to reduce generated and perceived noise.

If a transformer core is organized to have several distinct sections, as disclosed in this patent, the natural resonance frequency of the core may be lowered or altered.

Lower frequency sounds tend to be perceived (by a human) at a lower sound level in accordance with an equal-loudness contour, for example: a 40-phon contour.

A significant part of perceived noise loudness (by a human), may be due to harmonics. The natural mechanical resonance frequency of a transformer core may depend on many factors, including the size, weight, material, type of transformer, liquid/air cooled, etc. The fundamental noise frequency, due to magnestriction may be 100 Hz (for a 50 Hz ac system). Acoustic resonance may be responsible for amplification of higher frequency harmonic content, thereby increasing the perceived noise, by a human. Studies have shown the human ear to be the most sensitive in the region of 2 kHz-5 kHz.

If the natural mechanical resonance frequency of a transformer core can be reduced, by methods disclosed in the patent, this may reduce acoustic resonance amplification of higher frequency harmonics, thereby lowering the perceived noise level for a human.

In an experiment; the core of a test transformer (in accordance with the invention) was lightly struck with an object and the sound compared to a standard transformer struck with the same object. An audible lower tone emitted from the test transformer, compared to the standard transformer, (most notable when struck on one of the side limbs). Furthermore the perceived sound was lower for the test transformer compared to the standard transformer.

An Impulse in the time domain (or Dirac delta function) is known to stimulate a system, at all possible frequencies. An electrical current impulse may be injected at the primary coils (with the secondary coils short-circuited), in order to generate an impulse function. The mechanical return signal, through the core, may be recorded in the time domain by a sensor and converted to the frequency domain via a Fourier or FFT transform for frequency analysis.

A similar method is disclosed in European Patent: ES 2599 306 T3, assigned to: ABB RESEARCH LTD. A method and device to estimate the clamping force on a set of windings of a transformer.

Periodic Impulse Train

If the mechanical frequency response of the core is ignored, for the moment, it may be realized that the periodic “banging” of laminated plates together (due to magnetostriction) may cause an impulse train effect.

A periodic impulse train, repeating at time intervals of (0, T, 2T, etc) in the time domain, may result in a periodic impulse train at frequencies of (0, 2π/T, 4π/T, etc), in the frequency domain, amplified by a factor of (2π/T) as demonstrated in: Introduction To Communication Systems, Ferrel G. Stremler, p. 88, ISBN: 0-201-07259-9.

The core's mechanical frequency response may be convoluted in the frequency domain, (multiplied or filtered in the time domain), with the periodic impulse train. The importance of optimizing the frequency response of the core, (and reducing the magnetic flux density at flux transitional areas), in order to reduce transformer hum, may be realized.

Time Domain Mechanical Transient Response

The mechanical transient response uniquely characterize a system and may be obtained from a unity step (δ(t) function or impulse function. The disclosed organization, must (according to known theory), modify the transient time response and frequency domain characteristics.

Parameters including: maximum overshoot, delay time, rise time and the settling time may be obtained from a unity step function applied to a system.

Similar data may be obtained from an impulse function. In practice, parameters may be modified or optimized, by a transformer core, organized in accordance with the invention, in order to reduce generated vibrations, transmitted vibrations and generated noise, etc. The number of slits, spacing between slits, size of slits, etc. may be optimized.

Vibration Damping

Less mechanical vibrations may be transmitted through the core; due to a reduction in the structural-structural internal connections of the core. In large transformers, this may also result in a reduction of vibrations transmitted to other components, (for example the oil, tank, clamps, etc). Mechanical vibrations, caused by the coils, may be dampened when transmitted via the core.

Corner Losses

Corner losses may be reduced by the invention. Rounded corners of the slits at or near areas in the core where the direction of the generated magnetic flux may change (during normal operation), due to a bend or similar in the core, may help to create a partial smoother flux transitional area around sharp corners. Substantially rounded end-sections of the slits may help to reduce corner losses, during normal operation. It is not a simple matter to organize rounded corners in a transformer constructed from E and I laminations, since rounded corners will impact on the bobbin dimensions, circumference of electromagnetic coils (limiting the wire size and number of wire turns), window area, power handling formulas, known to transformer manufacturers, etc.

Transformer Construction

The transformer may be constructed as a dry-type transformer or a liquid-filled (or wet-type) transformer. The transformer may be organized to be a step-up transformer, a step-down transformer, a multi-voltage transformer, an isolation transformer or an auto-transformer, etc.

A Transformer or Inductor May be Used to:

A transformer as disclosed may be used in any electric or electronic application where previous art transformers were used. Audio transformers, power transformers, medical isolation transformers, mains power distribution transformers, step-up and step-down transformers, multi-phase transformers, or inductors used in mains systems or electronic systems etc.

Solar cells in combination with inverters are increasingly used. Transformers used in inverters may be organized in accordance with the invention. A Microwave oven transformer (MOT) and ferroresinant transformer may be organized as disclosed. Electric vehicles and charging stations are becoming increasingly popular and may use transformers as disclosed. Transformers used in vehicle battery chargers and many additional systems may benefit from a transformer as disclosed.

Consumers may prefer to use and install transformers with reduced leakage flux and noise pollution characteristics. The transformer market is highly competitive and attracts constant research to boost performance.

Test Transformer

A small (approximately 100 VA) test transformer was constructed, (in accordance with PCT/ZA2020/050001) and compared against a similar size, previous art, standard shell-type transformer (constructed from the same material: NOSS 50H470 using standard E-I laminations and modified E and I laminations). The laminated plates were 0.5 mm thick. Both the test transformer and standard transformer's laminations was laser cut from the same roll of transformer material, in order to minimize variances in construction methods.

The laminations of both transformers were not subjected to an annealing process, before conducting the tests. For both transformers, 85 plates were stacked alternatively through the bobbins (according to known shell-type transformer construction methods).

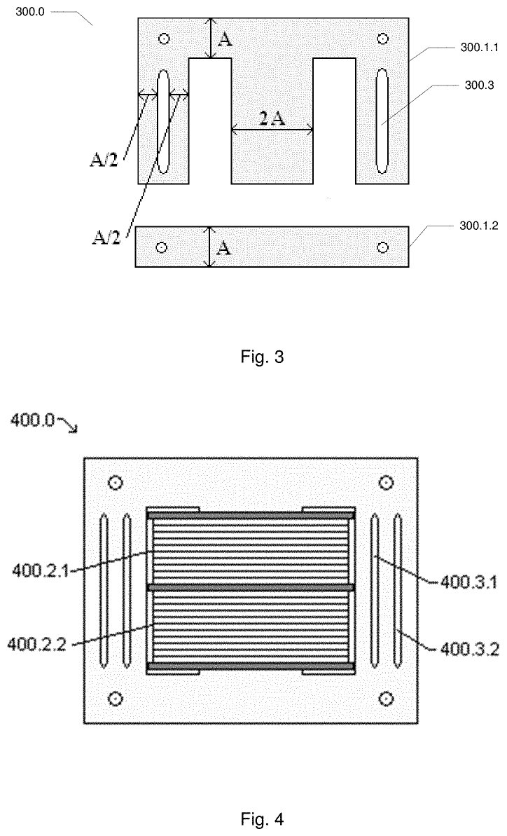

The test transformer was organized to have one slit through the center of each side limb. The slit was organized to be 5 mm wide. An area of 4 mm was left intact, at the end points of the side limbs of the E laminations. The edges of the slit were organized to be round, (see FIG. 3).

The electromagnetic coils were constructed around a bobbin. The transformer(s) were organized to operate from a 220V, 50 Hz AC source. Primary coil windings: 561; secondary coil windings: 36; computed flux density: 1.3 Tesla.

The same electromagnetic coil was used to test leakage flux of both the test and standard transformers (the laminations was swapped around the bobbin during tests).

The bobbin was a standard bobbin, (inside bobbin dimensions: 32 mm×45 mm). A double deck bobbin was used, (primary and secondary coils positioned in-line with each other). The bobbin was chosen because “random winding” methods could be used thereby eliminating the need to precisely wind turns next to each other.

A 2000 VA variac transformer (positioned between the mains and transformer under test), was used to precisely control the input voltage level, thereby eliminating variances in the mains voltage level, during tests.

Test Procedure

The transformer under test was connected to the 2000 VA variac via the primary coil. The output voltage of the variac was checked constantly (and small adjustments were made, if required, to maintain the voltage as close as possible to 220V).

A search coil was placed directly on top of the transformer, in an axial direction, compared to the transformer coils. The coil was also moved to a radial direction (compared to the transformer's coils) for measurements. The search coil was electrically connected to an analogue GW oscilloscope, GOS-522B 20 MHz. The peak-to-peak induced voltage level (of the search coil) was recorded. The search coil was also moved to various positions around the transformer, under test, to observe the maximum leakage flux.

The laminations of the standard transformer and the test transformer were swapped around the same transformer coil. In all cases the “E” and “I” laminations were aligned as precise as possible.

The same search coil was used for both tests. The search coil was positioned at the same positions for the tests. Both the test and standard transformers displayed the maximum leakage flux at the same positions (radial and axial).

Test Results

The test transformer (in accordance with the invention), displayed a reduction in the measured peak-to-peak leakage flux of approximately 33% (no-load) and approximately 45% (max loading via a resistor) compared to the standard, previous art transformer, with the search coil positioned directly on top of the transformers. Results may vary in other systems.

The test transformer displayed no noticeable signal distortion compared to the standard transformer, when the secondary output signals were viewed and compared on the oscilloscope.

### Alternative Solutions to the Patent

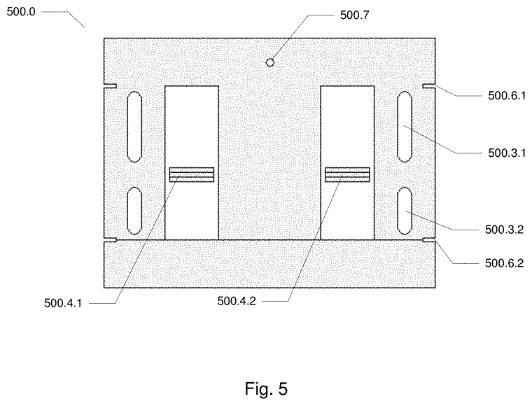

The cross-sectional area of the side limbs of the transformer core may be increased. This will increase the transformer weight. This type of approach will not reduce corner losses. At sharp corners, flux may be compressed to core saturation flux densities resulting in leakage flux (at the sharp corners). The patent disclose a method of creating partially rounded corners for a significant portion of magnetic flux circulating around the core, (see FIG. 3, FIG. 4, FIG. 5 and FIG. 7).

Manufacturing Stages

It should be noted that manufacturing stages is also protected by this invention. For example; any sub-components or laminations manufactured, in accordance with the invention.

The invention will now be further described, by way of example, with reference to the following diagrammatic drawings.

FIG. 1 shows a schematic diagram of a previous art shell-type transformer.

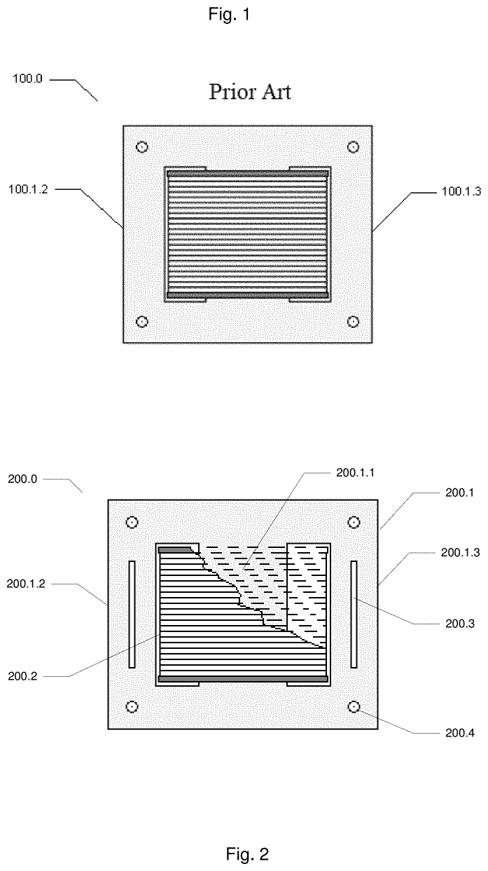

FIG. 2 shows a schematic diagram of one possible embodiment of a single-phase shell-type transformer, in accordance with the invention.

FIG. 3 shows a schematic diagram of one possible embodiment of the modified E and I laminations which may be used. Other embodiments are possible.

FIG. 4 shows a schematic diagram of one possible embodiment of a transformer, with multiple slits in the side limbs, in accordance with the invention.

FIG. 5 shows a schematic diagram of one possible embodiment of how the ferromagnetic core may be organized if magnetic shunts are used in the design.

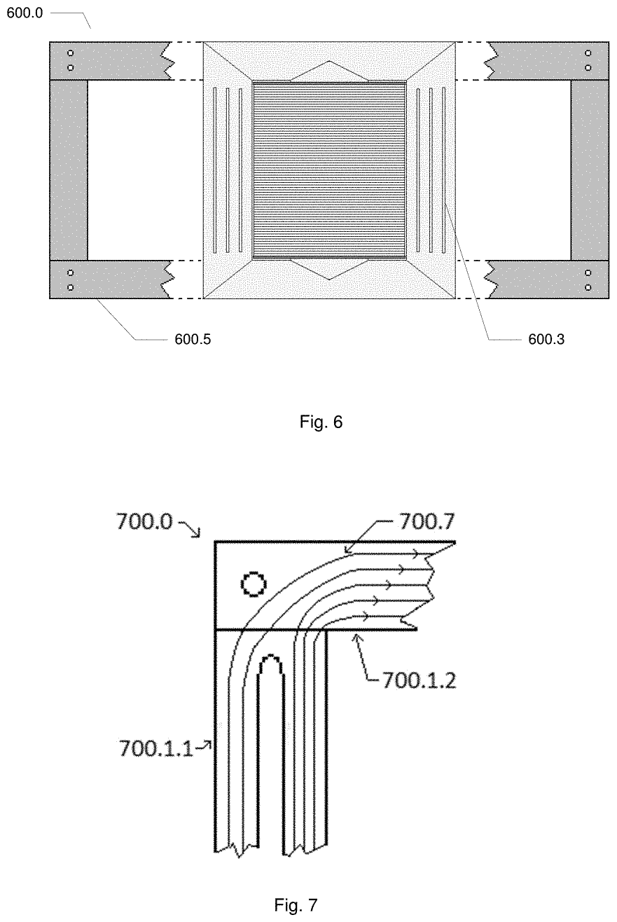

FIG. 6 shows a schematic diagram of one possible embodiment of a large shell-type transformer, constructed in accordance with the invention. An external clamp may be used to keep components in position.

FIG. 7 shows a schematic diagram of an expanded view of the flux transitional area at one side limb of an “E” lamination in mechanical connection with an “I” lamination.

It should be noted that in all the diagrams dimensions are not drawn to scale but serves to illustrate the principal of operation. Parameters may be determined experimentally. The drawings are incorporated and forming part of the specifications and together with the description serves to explain the principals involved in the invention.

Referring to FIGS. 1 to 7 of the drawings, in FIG. 1 the basic configuration of a previous art shell-type transformer is shown.

In FIG. 2 one possible embodiment of a shell-type transformer, in accordance with the invention, is shown. In FIG. 2 generally referred to by reference numeral 200.0 (see FIG. 2). The ferromagnetic core (200.1) may have a centre limb (200.1.1), encircled by the primary and secondary coils (200.2). In another embodiment (not shown) the primary and secondary coils may be positioned in-line with one another, around the centre limb (200.1.1).

The two ferromagnetic side limbs (200.1.2) and (200.1.3) may each have one or more slits (200.3) (cavities or similar), cut into the core.

The effective cross-sectional area of the side limbs (200.1.2), (200.1.3) may be designed to remain unchanged compared to a previous art shell-type transformer with the same power rating. Nuts and bolts (or similar), may be used to keep the assembly in position via mounting holes (200.4), according to known methods.

The operating principals have already been explained in detail in the description of this patent and are therefore not repeated here again. It will be noted that the side limbs (200.1.2), (200.1.3) and centre limb (200.1.1) may also be refer to as pillars and connecting structures as yokes, in the industry.

In FIG. 3 one possible embodiment of the modified E and I laminations is shown. In FIG. 3 generally referred to by reference numeral 300.0 (see FIG. 3), an “E” lamination (300.1.1) and an “I” lamination (300.1.2) is shown. The slits (300.3) holes or similar will be noted.

It will clearly be noted that; other embodiments are possible. For example; any number of slits (300.3) may be punched, laser cut (or similar), into the laminations. It will be noted that the width (or area) of the magnetic flux path is not reduced, by the slit(s) in the core, due to the organization. In larger type transformers the laminations (not shown) may be kept in position by an external clamp (or similar), (not shown).

In FIG. 4 one possible embodiment of a transformer with multiple slits in the side limbs is shown. In FIG. 4 generally referred to by reference numeral 400.0 (see FIG. 4). A transformer may be organized to have any number of slits (400.3.1), (400.3.2) or similar in the side limbs. The slits (400.3.1), (400.3.2) may be evenly spaced apart, as shown, or any other spacing arrangement may be used, not shown. The electromagnetic coils (400.2.1), (400.2.2) may be positioned in-line with each other or may be wound over each other (not shown).

In FIG. 5 one possible embodiment of a transformer with slits in the side limbs is shown with magnetic shunts. In FIG. 5 generally referred to by reference numeral 500.0 (see FIG. 5). If required, magnetic shunts (500.4.1), (500.4.2) may be positioned between one or more slits (500.3.1), (500.3.2).

The slits (500.3.1), (500.3.2) may be made the same size or two different E type laminations may be made (not shown). Magnetic shunts may for example be used in some microwave oven transformers. If required, the core may be designed to accommodate a grounding connection point, thermal sensor, or similar (500.7).

Welding ports (500.6.1), (500.6.2) may be used in mass produced systems, according to known methods. It will be realised that; if laminations are welded together (in mass produced systems), this may adversely effect generated heat, during normal operation. Advantageous, the cooling holes may be organized to be relative close to welding ports.

A Ferroresonant transformer with magnetic shunts, (not shown), may be organized in accordance with the invention.

In FIG. 6 one possible embodiment of a large shell-type transformer is shown. In FIG. 6 generally referred to by reference numeral 600.0, (see FIG. 6). The transformer may be organised to have any number of slits (600.3), in accordance with the invention. The corners of the slits may be organized to be substantially rounded (not shown). An external clamp (600.5) may be used to keep the components in position, according to known methods. The clamp (600.5) may be positioned so that it does not cover the slits (600.3) during final assembly or slits (not shown) may also be cut into the clamp (600.5). Known prior art methods, for example; step-lap mitred cores may be incorporated, etc.

In FIG. 7 a schematic diagram of an expanded view of the flux transitional area at one side limb of an “E” lamination in mechanical connection with an “I” lamination is shown, In FIG. 7 generally referred to by reference numeral 700.0 (see FIG. 7). Magnetic flux (700.7), generated during normal operation, may jump from the side limb of an “E” lamination (700.1.1) towards an “I” lamination (700.1.2) or vice versa (not shown).

It will be noted that; the magnetic flux density at the transitional area between the “E” and “I” lamination may be reduced due to an increase in the ferromagnetic area at the flux transitional area. A decrease in the flux density, at the transitional area between laminations, may result in a reduction of leakage flux and magnetostriction forces. This in turn may result in a reduction of noise generated during normal operation of the transformer. By organizing the corners of the slit to be substantially rounded (as shown), corner losses may be reduced, during normal operation.

With reference to FIG. 2 to FIG. 7, the side limbs of the core structure may be organized to have one or more slits or similar. Many variations may be made; for example: the cross-sectional area of the core may be organized to be round, (according to known methods).

What is claimed is:

1) An electric apparatus, comprising: a core (FIG. 2, 200.1), said core constructed from ferromagnetic laminated plates, said core organized to form a closed or substantially closed magnetic circuit, said core organised to have a centre limb (FIG. 2, 200.1.1) and side limbs (FIG. 2, 200.1.2, 200.1.3), one or more electromagnetic coils (FIG. 2, 200.2) organized to encircle said centre limb, said core further organized to have any number of slits (FIG. 2, 200.3; FIG. 3, 300.3) or similar inside the side limbs of said core, said slits organized to have any convenient size, said slits organized to allow air or oil or similar to flow through said slits, said slits further organized to increase the average ferromagnetic path-length, in all laminated plates, during normal operation.

2) An electric apparatus, comprising: a core, said core constructed from E and I type of ferromagnetic laminated plates, the side limbs of said E type of ferromagnetic laminated plates organized to have any number of slits or similar, one or more electromagnetic coils organized to encircle the centre limb of said core, said core further organized to form a closed or substantially closed magnetic circuit, where flux transitional areas between the side limbs of said E type of ferromagnetic laminated plates (700.1.1) of said core and said I type of ferromagnetic laminated plates (700.1.2) of said core are organized to cause a reduction in the magnetic flux density, during normal operation, where said flux is generated by at least one of said electromagnetic coil(s).

3) The core of an electric apparatus, said core constructed from ferromagnetic laminated plates, said core organized to form a closed or substantially closed magnetic circuit, said core organized to have a centre limb and side limbs, said side limbs organised to have any number of slits, the end-sections of said slits (FIG. 3, 300.3; FIG. 5 500.3.1, 500.3.2) organized to be substantially rounded.

4) The core of an electric apparatus, said core constructed from ferromagnetic un-laminated sections, said core organized to form a closed or substantially closed magnetic circuit, said core organized to have a centre limb and side limbs, said side limbs organised to have any number of slits, the end-sections of said slits (FIG. 3, 300.3) organized to be substantially rounded.

5) A process of altering the mechanical impulse transient response of an electric apparatus, during normal operation, via slits or similar, the process including, organizing said electric apparatus to have a ferromagnetic core (FIG. 2, 200.1) constructed from laminated plates, said core organized to form a closed or substantially closed magnetic circuit, said core organized to have a centre limb (FIG. 2, 200.1.1) and side limbs, said core further organized to have any number of slits (FIG. 2, 200.3; FIG. 3, 300.3) or similar inside the side limbs (FIG. 2, 200.1.2, 200.1.3) of said core, one or more electromagnetic coils organized to encircle said centre limb.

6) A transformer bank, constructed from three shell-type transformers, where each of said shell-type transformer comprise: a core (FIG. 2, 200.1), said core constructed from ferromagnetic laminated plates, one or more electromagnetic coils (FIG. 2, 200.2) organized to encircle a centre limb (FIG. 2, 200.1.1) of said core, said core further organized to have any number of slits (FIG. 2, 200.3; FIG. 3, 300.3) or similar inside the side limbs (FIG. 2, 200.1.2, 200.1.3) of said core, said slits organized to have any convenient size, said slits organized to allow air or oil or similar to flow through said slits, said slits further organized to increase the average ferromagnetic path-length, in all laminated plates, during normal operation.

7) The ferromagnetic core of an electric apparatus, said core organized to have a centre limb and two side limbs, said core further organized to have any number of slits (FIG. 3, 300.3) or similar of any convenient size inside the side limbs of said core, said core constructed from laminated E (FIG. 3, 300.1.1) and laminated I (FIG. 3, 300.1.2) type of laminations.

8) Any intermediate component or sub-component of the core of an electric apparatus, where said electric apparatus is organized to function as either a shell-type transformer or as a shell-type inductor, organized in accordance with claim 7.

9) A shell-type transformer with magnetic shunts (FIG. 5, 500.4.1, 500.4.2) organized in accordance with claim 1.

10) A shell-type transformer with magnetic shunts, organized to function as a ferroresonant transformer, organized in accordance with claim 3.
